(19) United States
(12) Patent Application Publication
(10) Pub. No.: US 2007/0107444 A1
(43) Pub. Date: May 17, 2007

(54) Tube on tube heat exchanger

(75) Inventors: Gus W. Cutting, Palm Harbor, FL (US); Nicholas A. Hartney, St. Petersburg, FL (US); Winston S. Webb, Key Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/280,685

(22) Filed: Nov. 16, 2005

(51) Int. Cl. F17C 9/02; F28D 7/10; F28D 7/02

(52) U.S. Cl. 62/50.2; 165/164; 165/154

(57) ABSTRACT

A heat exchanger that includes a first tube and a second tube. The first tube has at least one coil and a first diameter. The second tube also has at least one coil and a second diameter. The at least one coil of the first tube is positioned next to the at least one coil of the second tube such that thermal energy is exchanged between the at least one first and the at least one second coil.

### TECHNICAL FIELD

The present invention relates generally to heat exchangers.

### BACKGROUND

Fluids are used in various industries for certain heating or cooling applications. For example, fluids (liquid or gas) are used in heat exchangers. A heat exchanger is a device used to transfer thermal energy from one fluid to another fluid. The two fluids are held in separate containers that are thermally coupled to each other so that the transfer of thermal energy occurs. The use of heat exchangers for liquid cooling is used in industry for a variety of tasks. A typical refrigerant (or cooling) fluid used in industry is Freon. In a heat exchange system, the Freon is driven by compressors through its container to cool a working fluid in the other thermally coupled container.

Freon systems, however, tend to be very complicated, expensive, large and prone to frequent breakdowns. Another type of heat exchange system uses liquid nitrogen (LN₂) as a cooling fluid. LN₂ heat exchangers (or cooling systems) have an advantage over the Freon systems. One of the major advantages is that they have fewer moving parts. LN₂ systems, however, are difficult to design since the cold temperatures provided by the LN₂ can cause the exchanger to fracture or fail. Moreover, the working fluid in an LN₂ exchanger is also prone to freeze in the exchanger near the LN₂ inlet. In addition, the LN₂ can flood and remain in the exchanger even when the supply is turned off. This excess cooling energy causes the system to lose control and can take the product beyond its temperature limits.

For the reasons stated above and for other reasons stated below which will become apparent to those skilled in the art upon reading and understanding the present specification, there is a need in the art for an efficient and effective LN₂ heat exchange system that is not as susceptible to limitation of prior systems.

### SUMMARY OF INVENTION

The above-mentioned problems of current systems are addressed by embodiments of the present invention and will be understood by reading and studying the following specification.

In one embodiment, a heat exchanger is provided. The heat exchanger includes a first tube and a second tube. The first tube has at least one coil and a first diameter. The second tube also has at least one coil and a second diameter. The at least one coil of the first tube is positioned next to the at least one coil of the second tube such that thermal energy is exchanged between the at least one first and the at least one second coil.

In another embodiment, a method of manufacturing a heat exchanger is provided. The method includes forming one or more coils in a first conductive tube. Forming one or more coils in a second conductive tube and coupling the one or more coils of the first conductive tube next to the one or more coils of the second conductive tube such that thermal energy is transferred between the first and second tubes.

In yet another embodiment, a method of operating a heat exchanger is provided. The method includes pumping a working fluid through a first tube in a loop fashion. The first tube has at least one coil. Providing a liquid nitrogen (LN₂) supply to a first end of a second tube. The second tube also has least one coil that is thermally coupled to the at least one coil of the first tube. Exhausting out gas through a second end of the second tube and transferring thermal energy between the working fluid and the LN₂.

In still another embodiment, a heat exchange system is proved. The heat exchange system includes a means to transfer thermal energy between working fluid in at least one coil of a thermally conductive tube and liquid nitrogen LN₂ in at least one coil of a second thermally conductive tube.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is an illustration of a heat exchanger system of one embodiment of the present invention;

FIG. 2 is an illustration of another embodiment of the present invention including a layer of thermally conductive material;

FIG. 3 is a cross-sectional view of a heat exchanger of one embodiment of the present invention;

FIG. 4 is a flow diagram of illustrating the manufacturing of a heat exchanger of one embodiment of the present invention; and

FIG. 5 is flow diagram of a method of using a heat exchanger of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide an efficient LN₂ heat exchanger system that is not prone to the problems of prior systems. In particular, embodiments of the present invention provide a tube on tube embedded heat exchanger that provides a large surface area for exchanging thermal energy while minimizing volume. The tubes are bent into coils. The round shape of the coils provides the largest surface area for the smallest volume, thus a minimum amount of LN₂ collects in the exchanger while still allowing the maximum transfer of thermal energy between the working fluid and the LN₂. In addition, because there are no welds or joints in embodiments of the present invention, the chance of the exchanger cracking or failing due to thermal gradients is minimized. Moreover, because of the full contact of the coils, little LN₂ is wasted.

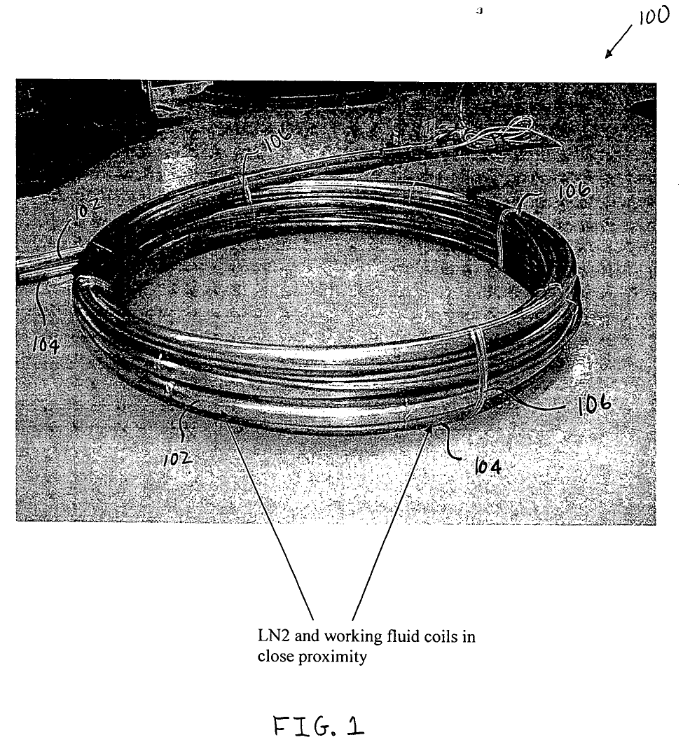

Referring to FIG. 1, an illustration of a heat exchanger 100 of one embodiment of the present invention is illustrated. Heat exchanger 100 includes two tubes 102 and 104. Each of the tubes 102 and 104 are formed into coils. The coils of the first and second tubes 102 and 104 are positioned next to each other so that thermal energy transfer between the first and second tubes 102 and 104 can be achieved. The coils of the first and second tubes 102 and 104 are held together by wires generally designated as 106. The tubes 102 and 104 are made from thermally conductive material that lends itself to being bent into coils such as copper or the like. Moreover, the number of coils formed in a tube can vary depending on the desired performance of the heat exchanger.

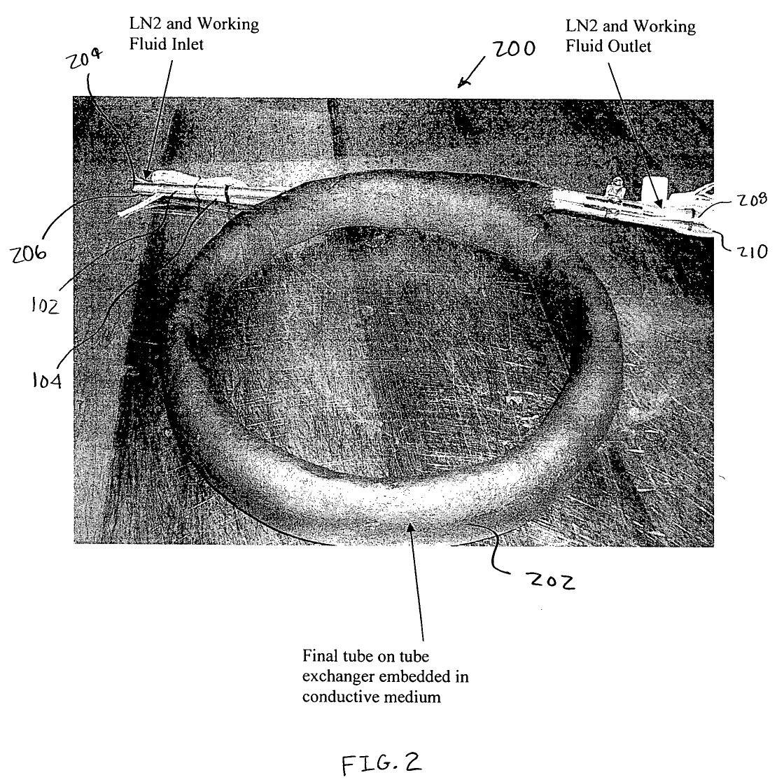

In one embodiment, the tubes 102 and 104 are of equal length but unequal in diameter. The lengths of the tubes are coiled into one or more circles of the same diameter and placed next to each other. In this embodiment, the tube 104 having the smaller diameter is connected to the LN₂ supply while the larger tube 102 is connected to the working fluid. FIG. 2, illustrates another embodiment of a heat exchanger 200 of the present invention. In this embodiment, conductive material 202 is encased around the coils of the first and second tubes 102 and 104 to enhance the transfer of thermal energy transfer between the LN₂ supply and the working fluid. In one embodiment, the conductive material 202 is conductive putty that hardens and bonds the coils of the first and second tubes together to further enhance thermal energy transfer.

As illustrated in FIG. 2, this embodiment of a heat exchange 200 resembles a torid having ends of the tubes sticking out. In particular, a first end 204 of the first tube 102 and a first end 206 of the second tube 104 is illustrated. Moreover, a second end 208 of the first tube 206 and a second end 210 of the second tube are also illustrated in FIG. 2. In one embodiment, the first end 206 of the second tube 104 is coupled to a supply of LN₂ and the second end 210 of the second tube 104 is coupled to an exhaust system. Moreover, in this embodiment, the working fluid is pumped through the first end 204 of the first tube 102 and out the second end 208 of the first tube 102 in a closed loop fashion.

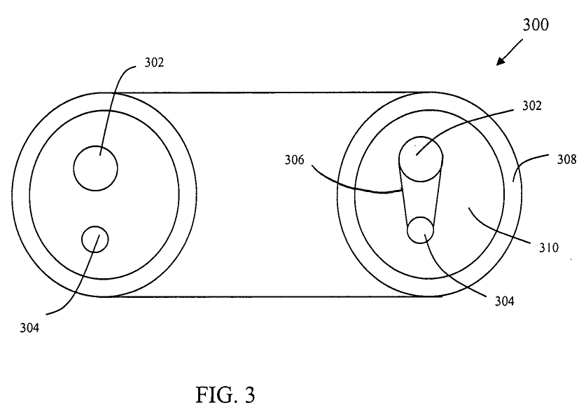

Referring to FIG. 3, a cross-section view of a heat exchanger 300 of one embodiment of the present invention is illustrated. As illustrated, in this embodiment, the heat exchanger includes a first tube 302 and a second tube 304. The first tube 302 has a larger diameter and is designed to hold the working fluid and the second tube 304 has smaller diameter and is designed to hold the LN₂. The first and second tubes are held in close proximity to each other by connector 306, which in one embodiment is a section of wire. A layer of conductive material 310 is formed around the first and second tubes 302 and 304 such that thermal energy transfer can occur between the fluids in the first and second tubes 302 and 304. A layer of insulation 308 is also provided to insulate the heat exchanger 300 from external environments.

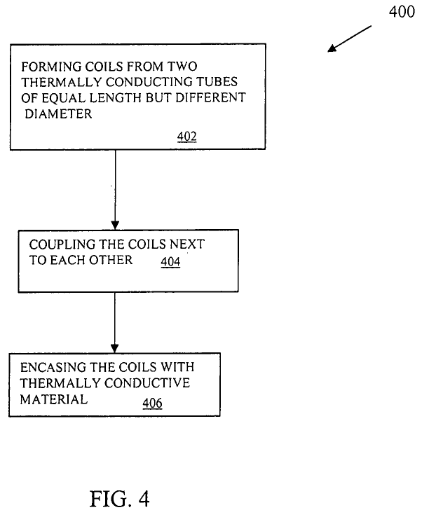

FIG. 4 is a flow diagram of a manufacturing process 400 in forming a heat exchanger of one embodiment of the present invention. The process beings by forming at least one coil in each of two thermally conductive tubes (402). In one embodiment, the tubes are of equal length but have different diameters. The at least one coils of the tubes are placed next to each other so that thermal transfer can be achieved between fluids (liquid or gas) in the tubes (404). In one embodiment, the coils are then encased with a thermally conductive material (406). The thermally conductive material in one embodiment, is a thermally conductive clay that hardens once it is positioned around the coils.

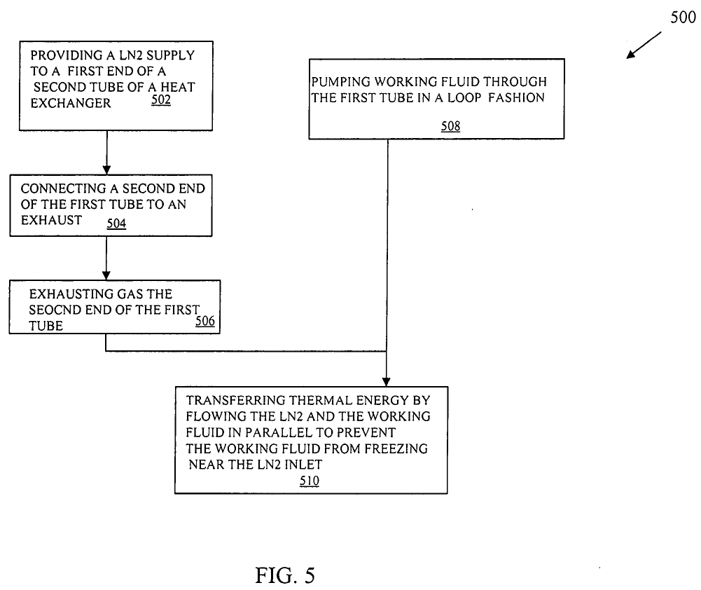

Referring to FIG. 5, a flow diagram of a method 500 for using one embodiment of the present invention is provided. The Method comprises pumping a working fluid through the first tube in a closed loop fashion (508). The method further comprises providing a LN₂ supply line to a first end of the second tube (502). A second end of the second tube is then coupled to an exhaust (504). Gas created by LN₂ is then exhausted through the second end of the second tube to the exhaust (506). Thermal energy is exchanged between the working fluid and the LN₂ (510). In one embodiment, the working fluid and the LN₂ flow in parallel with each other. This embodiment helps prevent the working fluid from freezing near the LN₂ inlet.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A heat exchanger comprising:
a first tube having at least one coil, the first tube having a first diameter; and
a second tube having at least one coil, the second tube having a second diameter, the at least one coil of the first tube being positioned next to the at least one coil of the second tube such that thermal energy is exchanged between the at least one first and the at least one second coil.

2. The heat exchanger of claim 1, further comprising:
conductive material encasing the one or more coils of the first and second containers and the wire heater.

3. The heat exchanger of claim 2, wherein the conductive material is a conductive putty adapted to harden after it is formed around the at least one first tube and the at least one second tube.

4. The heat exchanger of claim 1, wherein the first tube further comprises:
a first end adapted to receive a flow of liquid nitrogen (LN₂); and
a second end adapted to be coupled to an exhaust.

5. The heat exchanger of claim 1, further comprising:
the first tube adapted to contain a flow of working fluid, the first diameter of the first tube being larger than the second diameter of the second tube; and
the second tube adapted to contain a flow of LN₂.

6. A method of manufacturing a heat exchanger, the method comprising:
forming one or more coils in a first conductive tube;
forming one or more coils in a second conductive tube; and
coupling the one or more coils of the first conductive tube next to the one or more coils of the second conductive tube such that thermal energy is transferred between the first and second tubes.

7. The method of claim 6, wherein the first conductive tube has a different diameter than the second conductive tube.

8. The method of claim 6, further comprising:
encasing the one or more coils of the first and second tubes with a thermally conductive material.

9. The method of claim 8, wherein encasing the one or more coils further comprises:
forming thermally conductive clay around the one or more coils of the first and second tubes.

10. A method of operating a heat exchanger, the method comprising:
pumping a working fluid through a first tube in a loop fashion, the first tube having at least one coil;
providing a liquid nitrogen (LN₂) supply to a first end of a second tube, the second tube having least one coil that is thermally coupled to the at least one coil of the first tube;
exhausting out gas through a second end of the second tube; and
transferring thermal energy between the working fluid and the LN₂.

11. The method of claim 10, further comprising:
directing the flow of the working fluid to flow parallel to the flow of the LN₂.

12. A heat exchange system comprising:
a means to transfer thermal energy between working fluid in at least one coil of a thermally conductive tube and liquid nitrogen LN₂ in at least one coil of a second thermally conductive tube.

13. The method of claim 12, further comprising:
a means to exhaust gas from the second thermally conductive tube.

14. The method of claim 12, further comprising:
a means to flow the working fluid parallel to the flow of the LN₂.
